(19) United States
(12) Patent Application Publication
(10) Pub. No.: US 2009/0172560 A1
(43) Pub. Date: Jul. 2, 2009

(54) PORTABLE COMMUNICATION DEVICE HAVING HYPERLINK TARGETS FOR IMPROVED MOBILE WEB BROWSING

(75) Inventors: Gary R. Cole, Cary, NC (US); Jeffrey J. Griffin, Raleigh, NC (US); William M. Richey, Durham, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/015,876

(22) Filed: Jan. 17, 2008

Related U.S. Application Data
(60) Provisional application No. 61/018,082, filed on Dec. 31, 2007.

(51) Int. Cl. G06F 3/048

(52) U.S. Cl. 715/744; 715/733

(57) ABSTRACT

A portable communication device having a touch screen user interface is configured to provide mobile web browsing that makes use of hyperlink targets having modified size, display format and/or position. The modified hyperlink targets are more distinct to avoid incidental hyperlink activation while scrolling on a web page within a display window of the portable communication device.

### RELATED APPLICATION DATA

The present application claims the benefit of U.S. Provisional Application Ser. No. 61/018,082, filed Dec. 31, 2007, the disclosure of which is herein incorporated by reference in its entirety.

### TECHNICAL FIELD OF THE INVENTION

The present invention relates generally to portable communication devices, and more particularly, to a portable communication device having modified hyperlink targets for improved mobile web browsing.

### DESCRIPTION OF RELATED ART

In recent years, portable communication devices, such as mobile phones, personal digital assistants, mobile terminals, etc., continue to grow in popularity. As the popularity of portable communication devices continues to grow, the applications for and features of portable communication devices continue to expand. Portable communication devices are appealing to users because of their capability to serve as powerful communication, data service and entertainment tools.

The wireless industry has experienced a rapid expansion of mobile data services and enhanced functionality. In addition, the features associated with certain types of portable communication devices have become increasingly diverse. To name a few examples, many portable communication devices have text messaging capability, web browsing functionality, electronic mail capability, video playback capability, audio playback capability, image display capability and hands-free headset interfaces.

Most mobile phones include a liquid crystal display (LDC) to accommodate the information display requirements associated with today's mobile phones. In addition, touch input devices, such as touch screens, have become popular, especially for use in connection with handheld mobile web browsing devices. These devices typically have relatively small displays and can show only a portion of a web page. Many touch screen user interfaces allow a device user to pan around a web page by touching the screen and dragging a finger or stylus.

### SUMMARY

To improve web browsing using a portable communication device, the present disclosure provides a portable communication device and method of displaying web pages having hyperlink targets. The size, position and/or format of hyperlink targets in a typical web page may be modified to enhance web browsing using a portable communication device. By modifying the size, position and/or format of hyperlinks displayed on a portable communication device having a touch screen, inadvertent activation of hyperlinks within a web page may be reduced.

One aspect of the invention relates to a portable communication device that includes a housing, a touch input display disposed within the housing, and a web access interface stored in a memory on the portable communication device, wherein when the web access interface is executed, the web access interface causes the portable communication device to receive web data representative of a web page for display on the portable communication device, wherein the web page includes at least one hyperlink having a target size and a display format relative to the web page; modify the target size and/or display characteristic of the at least one hyperlink relative to the web page; and display the web page with the modified hyperlink on the touch input display.

According to another aspect, the web access interface causes the portable communication device to reduce the target size of the at least one hyperlink relative to the web page.

According to another aspect, the web access interface causes the portable communication device to adjust a position of the at least one hyperlink target relative to the web page.

According to another aspect, the web access interface causes the portable communication device to display the at least one hyperlink target adjacent to a border of a viewing window on the touch input display.

According to another aspect, the hyperlink target is displayed with a visual indicator connecting the modified hyperlink target with associated hyperlink text or image.

According to another aspect, modifying the display format of the at least one hyperlink includes displaying a pop up confirmation prompt in association with a hyperlink, wherein the pop up confirmation prompt is presented in response to detection of activation of a hyperlink on the web page.

Another aspect of the invention relates to a method of displaying a web page having hyperlinks on a portable communication device. The method includes receiving web data representative of a web page for display on the portable communication device, wherein the web page includes at least one hyperlink having a target size and a display format relative to the web page, modifying the target size and/or display format of the at least one hyperlink relative to the web page, and displaying the web page with the modified hyperlink on a display of the portable communication device.

According to another aspect, modifying includes reducing the target size of the at least one hyperlink.

According to another aspect, modifying the display format of the at least one hyperlink includes reformatting the hyperlink such that only a portion of the original hyperlink target is active in the modified hyperlink.

According to another aspect, the original hyperlink includes a word or phrase, and only the first letter of the word or phrase of the original hyperlink is active in the modified hyperlink.

According to another aspect, the original hyperlink includes an image or an icon, and only a portion of the image or icon is active in the modified hyperlink.

According to another aspect, modifying includes adjusting a position of the at least one hyperlink target relative to the web page.

According to another aspect, modifying includes moving the at least one hyperlink target adjacent to a border of a viewing window on the display.

According to another aspect, the modified hyperlink target includes a visual indicator connecting the modified hyperlink target with an associated hyperlink text or image.

According to another aspect, modifying includes displaying a pop up confirmation prompt in association with a hyperlink, wherein the pop up confirmation prompt is presented in response to detection of activation of a hyperlink on the web page.

Another aspect of the invention relates to a method of displaying a web page having hyperlinks on a portable communication device that includes receiving web data representative of a web page for display on the portable communication device, wherein the web page includes at least one hyperlink of a first target size and a display characteristic relative to the web page; providing a user of the portable communication device with a prompt to temporarily disable hyperlinks in the web page for display; disabling hyperlinks in response to a user command to temporarily disable hyperlinks on the web page; and displaying the web page with the at least one hyperlink disabled.

According to another aspect, providing a user of the portable communication device with a prompt includes displaying a soft key that is activatable to disable hyperlinks in the web page for display.

According to another aspect, the method includes providing the user with a control operative to disable hyperlinks on the web page when the control is engaged by the user of the portable communication device.

Another aspect of the invention relates to a method of providing web data for display on a portable communication device that includes storing web data representative of a web page, the web page including at least one hyperlink having a target size and a display format, determining whether a requesting device is a portable communication device, and if the requesting device is a portable communication, changing the target size and/or display format of the at least one hyperlink for display on the portable communication device.

Another aspect of the invention relates to a method of web browsing on a portable communication device that includes, for web data representative of a web page, where the web data includes at least one hyperlink having a target size and a display format relative to the web page, changing a target size, display position and/or display format of the at least one hyperlink relative to the web page for display on the portable communication device.

According to another aspect, the changing is performed by a web browser stored in a memory of the portable communication device.

According to another aspect, the changing is performed by a web server in data communications with the portable communication device.

Another aspect of the invention relates to a portable communication device that includes a housing, a touch input display disposed within the housing, and a web access interface stored in a memory on the portable communication device, wherein the web access interface provides a web access user interface in which hyperlink targets within web pages are displayed with reduced target size, modified target position and/or modified display format to reduce incidental activation of hyperlinks during web page navigation.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a diagrammatic illustration of a communications system including a portable communication device on which aspects of the technology may be carried out;

FIG. 2 is a front view of a mobile phone having a touch input display as an exemplary portable communication device on which aspects of the invention may be carried out;

FIG. 3 is a block diagram of the exemplary portable communication device of FIG. 2;

FIG. 4 is a flow chart or functional diagram representing a method of displaying a web page having hyperlinks on the exemplary portable communication device of FIG. 2;

FIG. 5 is a diagrammatic illustration of a mobile phone having hyperlink targets modified in accordance with one exemplary embodiment;

FIG. 6 is a diagrammatic illustration of a mobile phone having hyperlink targets modified in accordance with another exemplary embodiment;

FIG. 7 is a diagrammatic illustration of a mobile phone having hyperlink targets modified in accordance with another exemplary embodiment;

FIG. 8 is a flow chart or functional diagram representing another method of displaying a web page having hyperlinks on the exemplary portable communication device of FIG. 2;

FIG. 9 is a diagrammatic illustration of a mobile phone displaying a web page in accordance with another exemplary embodiment; and

FIG. 10 is a flow chart or functional diagram representing a method of providing web page data for display on a portable communication device.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

Touch screens are becoming more popular with handheld mobile web browsing devices. These devices typically have relatively small displays and can only display a portion of a web page. The touch screen user interface typically allows the user to pan around the web page by touching the screen and dragging a finger or a stylus. Hyperlinks on web pages typically are large targets defined by underlined text and pictures or icons. A current trend is to make the hyperlinks large and easily selectable for convenience of the user. While this design may work well with mouse-based systems for web browsing on personal computers, it can make touch-screen-based systems more difficult to navigate due to inadvertent touches or activations of hyperlinks while attempting to scroll a page on the display, thereby causing the web browser to launch to the selected hyperlink.

The present disclosure recognizes the problem with large links used in connection with mobile web browsing applications, and describes a method for making hyperlinks more distinct for use with touch screen user interfaces to avoid incidental touches while scrolling the page within the display window. The disclosed method includes modifying the target size, display format/characteristics and/or position of hyperlinks when engaging in mobile web browsing using a portable communication device. As is described more fully below, the modification of hyperlinks for mobile web browsing may be carried out via a portable communication device or via a web server in data communication with a portable communication device.

As referred to herein, the term “portable communication device” includes portable radio communication equipment. The term “portable radio communication equipment”, which herein after is referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of handheld mobile electronic equipment equipped with web browsing functionality.

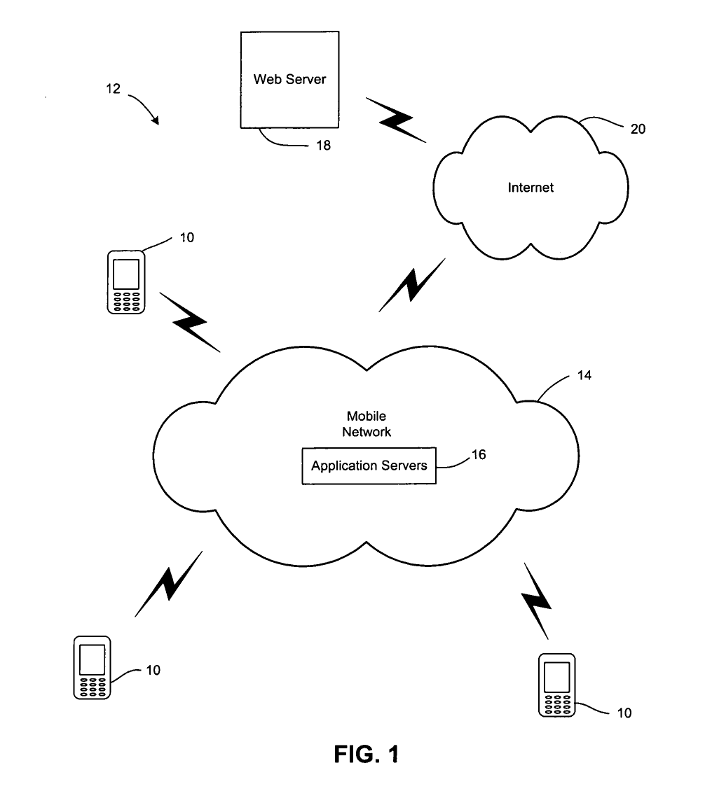

Referring initially to FIG. 1, a portable communication device 10 may be configured to operate as part of a communication system 12. The communication system 12 includes a mobile network 14, such as a mobile cellular telephony network, that facilitates communication, such as voice communication and/or data transfer between a plurality of portable communication devices 10, such as mobile phones, mobile terminals or the like. The mobile network 14 includes one or more servers (referred to generally as application server 16) for managing calls placed by and destined to the portable communication device 10, as well as supporting one or more applications (e.g., a web browsing application) by (e.g., including appropriate hardware and/or application programs for generating, transmitting and receiving personality profiles). In the illustrated embodiment, the portable communication device may engage in web browsing (e.g., viewing web pages) by receiving web page data from a web server 18 via the Internet 20. For purposes of the present disclosure, the portable communication device 10 will be described in terms of receiving web data representative of web pages having hyperlinks of a given target size, position and/or display format.

It will be appreciated that the mobile network 14 includes a network infrastructure, portions of which are used or otherwise accessed by the portable communication devices. The portable communication devices 10 may interact with each other and/or the network infrastructure in accordance with any suitable communication standard, including, but not limited to, Advanced Mobile Phone Service (AMPS), Digital Advanced Mobile Phone Service (D-AMPS), General Packet Radio Service (GPRS), Universal Mobile Telecommunications System (UMTS), Global System for Mobile Communications (GSM), Code Division Multiple Access (CDMA), Worldwide Interoperability for Microwave Access (WiMax), Voice-Over IP (VoIP), Session Initiated Protocol (SIP), Wireless Local Area Network (WLAN) or the like. In other words, the communication system shown in FIG. 1 is provided for purposes of explaining aspects of the present invention, without limiting the invention to a particular communication system design, architecture or communication standard. Further aspects of the invention may be employed in the connection with device-to-device exchanges (wired, wireless or via intermediary).

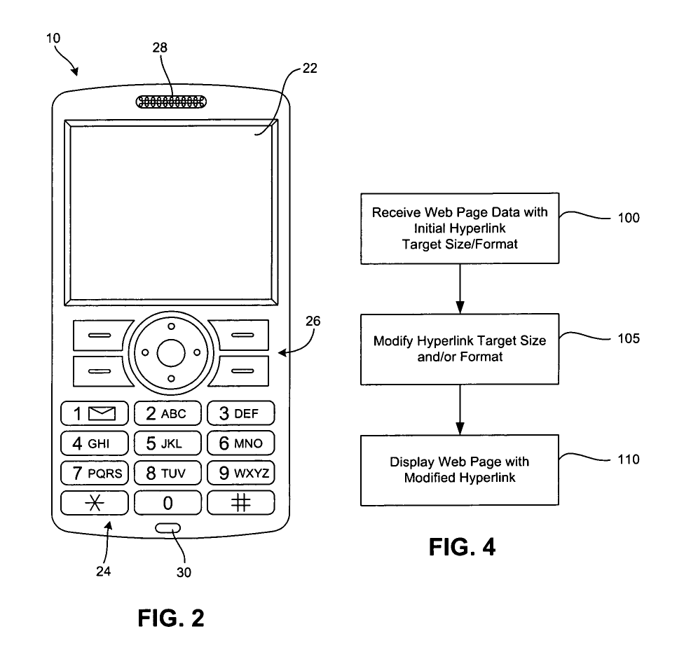

Turning now to FIG. 2, a portable communication device 10 is shown in accordance with the present invention. In the exemplary embodiment described herein, the portable communication device is a mobile phone 10. Of course, it will be appreciated that the present invention is applicable to other portable communication devices. The mobile phone 10 is shown as having a “block” or “candy bar” type of housing 12, but it will be appreciated that other form factor or housing types, such as clamshell or slide-type housings may be utilized without departing from the scope of the present invention.

In the illustrated embodiment, the mobile phone 10 includes a touch input display 22 (also referred to simply as a touch screen or a touch display), an alphanumeric keypad 24, one or more functional keys 26, e.g., a joystick or rocker key, a speaker 28 and a microphone 30. The alphanumeric keypad 24 and the functional keys 26, facilitate controlling operation of the mobile phone 10 by allowing for entry of alphanumeric information, such as telephone numbers, phone lists, contact information, notes and the like. The functional keys 26 typically facilitate navigation through various user menus including initiating and conducting phone calls and other communications.

The touch input display 22 displays information to a user, such as recorded digital media, e.g., recorded photos and videos, operating state, time, phone numbers, contact information and various navigational menus, which enable the user to utilize the various features of the mobile phone 10. In addition, the touch input display 22 is configured to receive user input via detection of user touch of the display, e.g., a touch by finger or by stylus. As is discussed more fully below, the touch input display is configured receive user input indicative of web browsing navigation, such as scrolling, activation of hyperlinks within web pages, and the like. Artisans will appreciate that the mobile phone 10 further includes suitable circuitry and software for performing various functionality. The circuitry and software of the mobile phone is coupled with input devices, such as the alphanumeric keypad 24, the functional keys 26 and the microphone 30, as well as to the input/output devices, including the touch input display 22 and the speaker 28. It will be appreciated that the touch input display may have any suitable size, shape and positioning without departing from the scope of the present invention. Also, while the exemplary mobile phone 10 is described as having a keypad 24, functional keys 26, and a touch input display 22, it will be appreciated that the mobile phone may include only the touch input display 22 as the primary means for receiving alphanumeric user input and/or navigation commands.

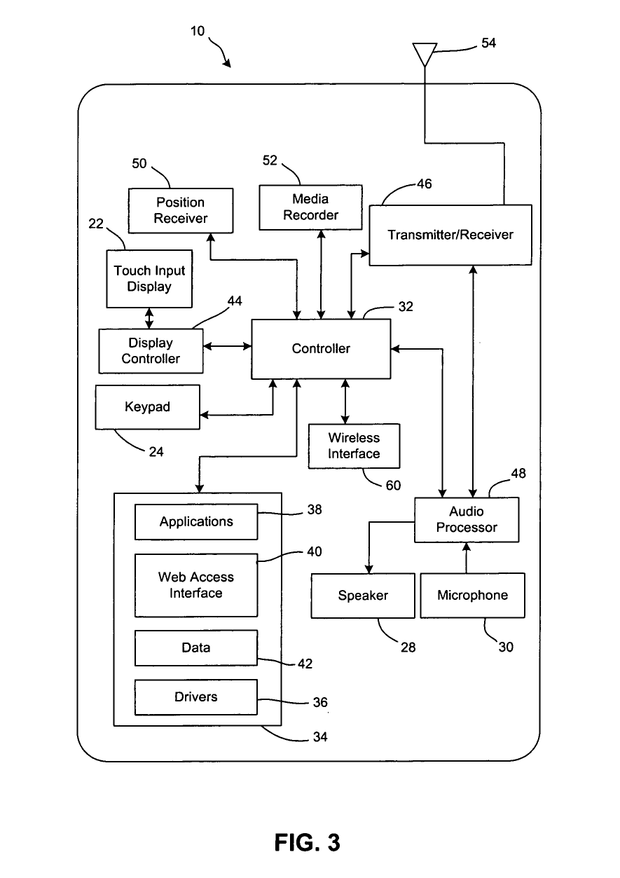

FIG. 3 represents a functional block diagram of a portable communication device 10. The portable communication device 10 includes a controller 32 that controls the overall operation of the portable communication device. The controller 32 may include any commercially available or custom microprocessor or microcontroller. Memory 34 is operatively connected to the controller 32 for storing control programs and data used by the portable communication device. The memory 34 is representative of the overall hierarchy of memory devices containing software and data used to implement the functionality of the portable communication device in accordance with one or more aspects described herein. The memory 34 may include, for example, RAM or other volatile solid-state memory, flash or other non-volatile solid-state memory, a magnetic storage medium such as a hard disk drive, a removable storage media, or other suitable storage means. In addition to handling voice communications, the portable communication device 10 may be configured to transmit, receive and process data, such as web data communicated to and from a web server, text messages (also known as short message service or SMS), electronic mail messages, multimedia messages (also known as MMS), image files, video files, audio files, ring tones, streaming audio, streaming video, data feeds (e.g., podcasts) and so forth.

In the illustrated embodiment, memory 34 stores drivers 36 (e.g., I/O device drivers), application programs 38, a web access interface 40 (also referred to as a web browser, a mobile web browser or a web browsing program), and application program data 42 (e.g., personality profiles created and/or received by the portable communication device). The I/O device drivers include software routines that are accessed through the controller 32 (or by an operating system (not shown) stored in memory 34) by the application programs, including the web access interface 40, to communicate with devices such as the display 22 and keypad 24 (e.g., a standard keypad, a QWERTY keypad or a touch screen keypad) as well as other input/output ports. The touch input display 22 is operatively coupled to and controlled by a display controller 44 (e.g., a suitable microcontroller or microprocessor) and configured to facilitate touch input functionally (detection of user touch of the display and recognition of desired user input based on the touch of the display).

The application programs, including the web browsing program 40, comprise programs that implement various features of the portable communication device 10, such as voice calls, e-mail, Internet access, multimedia messaging, contact manager and the like. As is described more fully below, the web access interface comprises a program, logic routine or code that modifies hyperlinks associated with web pages for improved viewing and navigation on the display of a portable communication device.

A person having ordinary skill in the art of computer programming, and specifically in applications programming for mobile phones, will consider it obvious in view of the provided description how to program a mobile phone to operate and carry out the functions described herein with respect to the web access interface 40 (and any interfacing between the web access interface 40 and other application programs (e.g., messaging application programs, such as a universal messenger program, media application programs and the like). Accordingly, details as to the specific programming code have been left out. Also, while the web browsing functionality may be carried out via the controller 32 and web access interface 40 (alone or in conjunction with other application programs) in memory 34 in accordance with inventive aspects, such function also could be carried out via dedicated hardware, firmware, software or combinations thereof without departing from the scope of the present invention.

With continued reference to FIG. 3, the controller 32 interfaces with the aforementioned display 22 and keypad 24 (and any other user interface device(s)), a transmitter/receiver 46 (often referred to as a transceiver), audio processing circuitry, such as an audio processor 48, and a position determination element or position receiver 50, such as a global positioning system (GPS) receiver. The portable communication device 10 may include a media recorder 52 (e.g., a still camera, a video camera, an audio recorder or the like) that captures digital pictures, audio and/or video. Image, audio and/or video files corresponding to the pictures, songs and/or video may be stored in memory 34 (e.g., in the case of music or video files, in a local media content database, metadata or other information associated with which may be used in the creation and/or modification of a personality profile).

An antenna 54 is coupled to the transmitter/receiver 46 such that the transmitter/receiver 46 transmits and receives signals via antenna 46, as is conventional. The portable communication device includes an audio processor 48 for processing the audio signals transmitted by and received from the transmitter/receiver. Coupled to the audio processor 48 are the speaker 28 and microphone 30, which enable a user to listen and speak via the portable communication device. Audio data may be passed to the audio processor 48 for playback to the user. The audio data may include, for example, audio data from an audio file stored in the memory 34 and retrieved by the controller 32 or audio data associated with a generated or received media-enhanced text message. The audio processor 48 may include any appropriate buffers, decoders, amplifiers and the like.

The portable communication device also may include one or more local wireless interfaces (indicated generally as wireless interface 60), such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the portable communication device 10 to the adapter, another mobile radio terminal, a computer, or any other electronic device. Also, wireless interface 60 may be representative of an interface suitable for communication within a cellular network or other wireless wide-area network (WWAN).

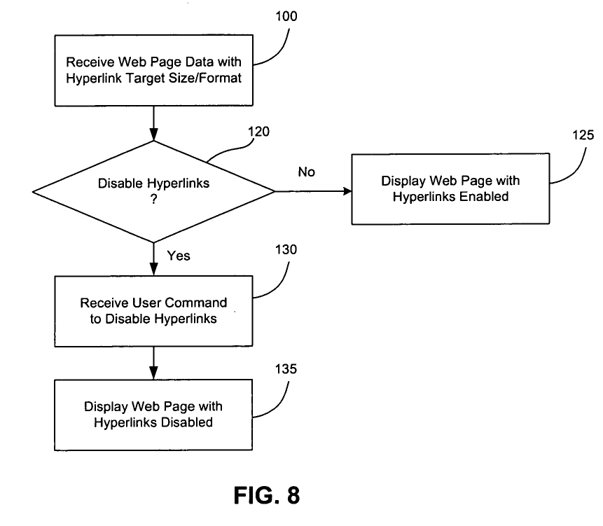

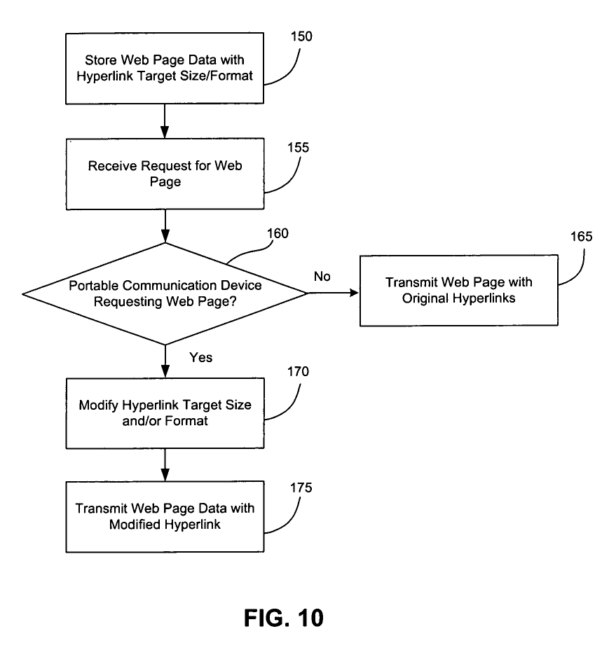

While for purposes of simplicity of explanation, the flow charts or functional diagrams in FIG. 4, FIG. 8 and FIG. 10 include a series of steps or functional blocks that represent one or more aspects of the relevant operation of the portable communication device 10 (or a web server 18 in data communication with the portable communication device 10). It is to be understood and appreciated that aspects of the invention described herein are not limited to the order of steps or functional blocks, as some steps or functional blocks may, in accordance with aspects of the present invention occur in different orders and/or concurrently with other steps or functional blocks from that shown or described herein. Moreover, not all illustrated steps or functional blocks of aspects of relevant operation may be required to implement a methodology in accordance with an aspect of the invention. Furthermore, additional steps or functional blocks representative of aspects of relevant operation may be added without departing from the scope of the present invention.

The methodologies illustrated in FIG. 4, FIG. 8 and FIG. 10, which may be implemented on or through a portable communication device, relate to methods of displaying a web page having hyperlinks on a portable communication device, methods of web browsing on a portable communication device, and/or methods of providing web data for display on a portable communication device. Turning now to FIG. 4, a method of displaying a web page having hyperlinks on a portable communication device begins at functional block 100, where the portable communication device receives web data representative of a web page having hyperlinks of a given target size and/or display format or display characteristic. For example, a portable communication device may initiate a web browsing session by connecting to or otherwise communicating with a web server via the Internet, through a mobile network, WiFi hotspot or the like to receive requested data from a web server. Upon request of web data from a web server, (e.g., by a user entering a given URL into a web browser's web address field) the portable communication may receive web data, e.g., HTML data, from a web server. The web data may include one or more hyperlinks, which are configured to be displayed with a given target size and/or display format or display characteristic. For example, received web page data may include hyperlinks made up of words or phrases having special formatting of the text, such as underlining, bolding, distinctive coloring or the like. Often, an entire word or phrase may be used as a target for selecting the given hyperlink. Also, images and icons, which often are rather large, may be used as hyperlinks. Because web pages typically are designed for viewing on a larger display, such as a display associated with a personal computer, the hyperlink targets may be relatively large and easily selectable for convenience of the user. While such a design works well with mouse-based systems, it can make web page navigation more difficult using touch-based portable communication devices due to unintentional launching of other websites due to inadvertent activation of hyperlinks within the web page.

At functional block 105, the portable communication device may operate to modify or otherwise alter the target size, position, and/or display format/characteristic of the hyperlinks received with the received web page data (functional block 100). For example, a portable communication device (through its web browsing software or other display engine software) may reduce the target size of a given hyperlink, alter the position of the given hyperlink relative to the text with which it is associated, and/or modify the display format or characteristic of the hyperlink. As is discussed below, this may be presented to the user in a number of ways. At functional block 110, the portable communication device may display the web page having the modified hyperlinks on the device display, e.g., on the touch input display.

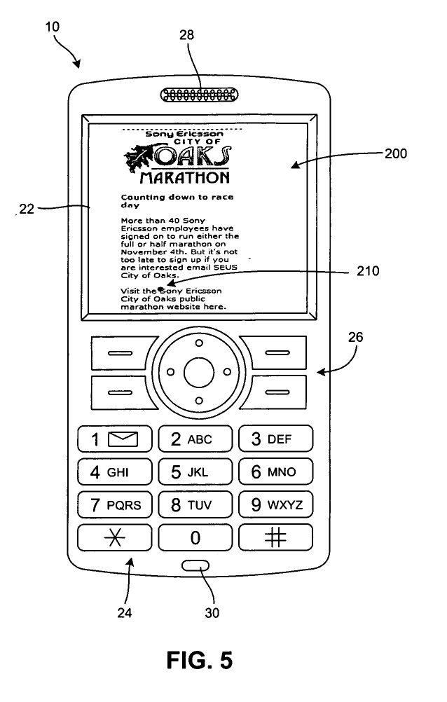

FIG. 5 shows one example of a web page display having hyperlinks modified in accordance with an aspect of the disclosed technology. For example, a mobile phone 10 is shown with an exemplary web page 200 provided on the device display 22. The web page includes modified hyperlink 210, which is visually represented as a small circle or dot on or near the first letter of what originally was a relatively large hyperlink (a string of text—“Sony Ericsson City of Oaks”). In this exemplary embodiment, the size, position and display format of the hyperlink has been changed, but the modified hyperlink still is associated with the original hyperlink target text (“Sony Ericsson City of Oaks”). In an alternative embodiment, the first letter of the original hyperlink may be active, while the remaining text is inactive, that is, the displayed hyperlink may include only the first letter of a word or string of text based on the original hyperlink. For example, in the case of FIG. 5, only the “S” in Sony may be presented as the active hyperlink target. Alternatively, in the case of the original hyperlink being an image or icon (e.g., a thumbnail photo), a small portion of the image may be active as the hyperlink, such as a corner of the image.

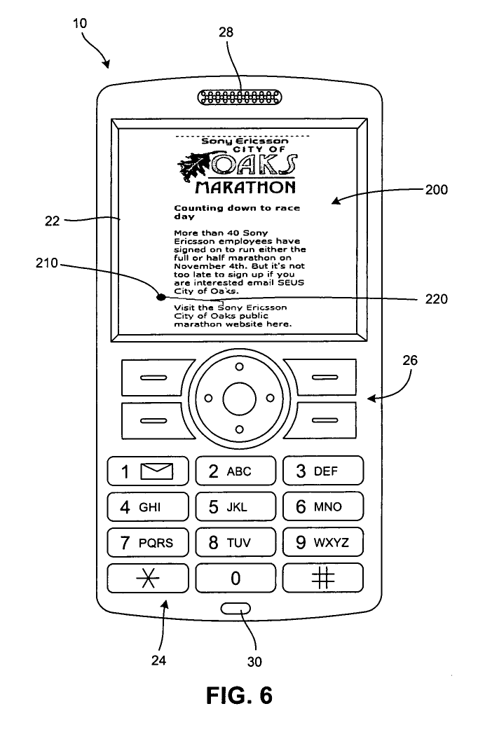

FIG. 6 shows another example of a web page having modified hyperlinks for display on a mobile phone display. The web page includes modified hyperlink 210, which is visually represented as a small circle or dot positioned near the border or edge of the viewing window of the phone display. This hyperlink modification and repositioning would serve to remove hyperlink targets from the region of the screen often accessed during scrolling. Such a hyperlink modification also would make it easier for a user to select different targets when the web page is viewed in a zoomed out view and two or more hyperlinks are in close proximity to one another. As can be seen in FIG. 6, the small hyperlink dot 210 includes a connecting line 220 associating it with the original hyperlink target text (“Sony Ericsson City of Oaks”).

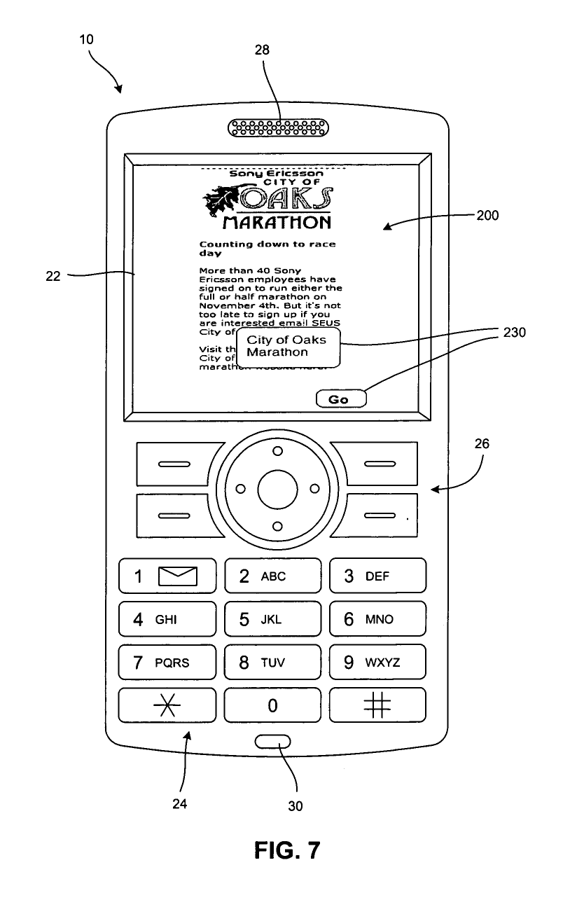

FIG. 7 shows another example of a web page having modified hyperlinks for display on a mobile phone display. In this exemplary embodiment, the hyperlink includes a popup 230 that is displayed when the hyperlink is “touched” by the user's finger or stylus. As shown in FIG. 7, a popup soft key 230 identifying the contacted hyperlink (“City of Oaks Marathon”) is displayed along with a soft key, e.g., “Go,” allowing the user to confirm activation of the hyperlink and launching of the alternate web site associated with the hyperlink. In one embodiment, movement of the user's finger, stylus or other navigation element away from the area containing the hyperlink and popup would cause the popup to disappear. As with the other above-discussed embodiments, this feature would enhance mobile web browsing by reducing or elimination inadvertent launching of hyperlinked websites.

It will be appreciated that the web page views and hyperlink modifications in FIGS. 5-7 are provided for purposes of example. Other modifications to the target size, position and/or display format of hyperlinks provided for mobile web browsing may occur without departing from the scope of the present invention. The various embodiments discussed above may be combined with one another without departing from the scope of the present invention.

Turning now to FIG. 8, another method of displaying a web page having hyperlinks on a portable communication device is provided. The method begins at functional block 100 where the portable communication device receives web data representative of a web page having one or more hyperlinks of a given target size, position and/or display format/characteristic. As is discussed above with respect to FIG. 4, the portable communication device may receive web page data from a web server during a web browsing session. At functional block 120, the portable communication device may includes an indicator, such as a soft key or the like, or another control mechanism (e.g., a hard key on the phone) which allows the device user to select disabling of hyperlinks on the web page represented by the received web page data. Of course, if the device user does not select the “disable hyperlinks” key, or otherwise designate “disable hyperlinks” as a default or user preference, at functional block 125, the web page will be displayed with hyperlinks enabled (as is done normally during a web browsing session).

If the user decides to disable hyperlinks (and commands the portable communication device to disable hyperlinks via activation of a “disable hyperlinks” key or designation of “disable hyperlinks” as a default or user preference), at functional block 130, the portable communication device may receive a user command (e.g., via user selection of the “disable hyperlinks” soft key or via another suitable manner) to disable hyperlinks in the web page represented by the received web page data. If the portable communication device receives a “disable hyperlinks command,” at functional block 135, the portable communication device may display the web page (or a string of web pages) with hyperlinks disabled, that is, the web page may be displayed with conventional hyperlinks and/or hyperlinks modified in accordance with the method(s) described more fully above. However, while the display format and/or display characteristic text may appear in the web page as displayed on the portable communication device, the hyperlinks will be temporarily disabled or otherwise inactive such that when a device user positions a display cursor (e.g., by the user touching the touch display with a finger or stylus on or in close proximity to hyperlink target) and even takes action consistent with selecting or activating a hyperlink target (intentionally or inadvertently) the portable communication device will not activate the hyperlink and launch the web page associated with the hyperlink target. In this manner, the temporary disablement of hyperlinks allows the user of a touch screen mobile phone to navigate a web page without worry of inadvertently activating a hyperlink and navigating to different web page associated with the inadvertently-selected hyperlink. Of course, during web navigation, the user may choose to re-enable hyperlinks in displayed web pages, for example, by de-selecting the “disable hyperlinks” soft key or by otherwise enabling hyperlinks as a default or user preference (e.g., through a drop down menu or by another suitable user interface mechanism), thereby making hyperlinks available again during web browsing. It will be appreciated that the “disable hyperlinks” setting may be activated on a page-by-page basis or may be designated for entire web browsing sessions or set as an overall default.

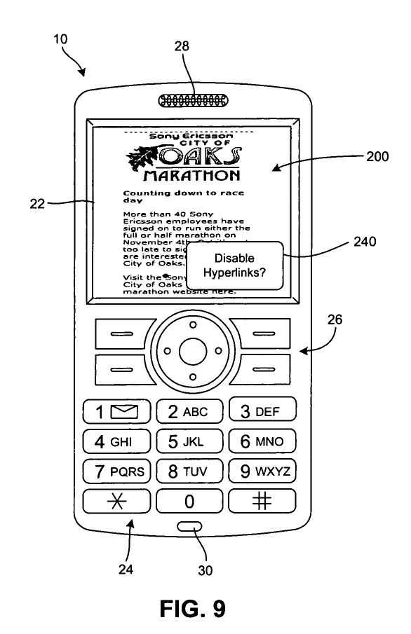

FIG. 9 provides a diagrammatic illustration of a mobile phone having a “disable hyperlinks” soft key 240. The phone in the illustrated embodiment is displaying a web page along with a “disable hyperlinks” soft key 240. It is to be appreciated that the illustration in FIG. 9 is simply for purposes of example, and that the location, size or display format of the soft key 240 may vary without departing from the scope of the present invention. Further, the concept of a temporary disablement of hyperlinks is not limited to user actuation of a soft key displayed on the phone's display. Other methods may be provided such as entering an alphanumeric code to disable and/or enable hyperlinks during web browsing, user actuation of a dedication hard key or the like.

Referring now to FIG. 10, a method of providing web data for display on a portable communication device is provided. The method begins at functional block 150 where web page data is stored, e.g. on a web server or other appropriate storage device, where the web page data includes hyperlinks having a first or predetermined target size, position and or display format or characteristic relative to the web page. As is described above with reference to FIGS. 4 and FIG. 8, the web data representative of a webpage may include designs to display hyperlinks using specialized formatting of the text, such as underline, bold, or specific coloring. Further, the initial hyperlink target size may be relatively large, for example, entire words, phrases or images.

At functional block 155, the web server receives a request for web data representative of a web page. Such request can include any typical request when a user who is engaging in web browsing looks to access a webpage, for example, by entering a specific URL into a web browser. Optionally, at functional block 160, the web browser may determine whether a portable communication device is requesting the webpage. This determination may be made in a number of ways. For example, information regarding the client (portable communication device) and limitations associated with the client may be communicated back and forth during a web browsing session. Alternatively, the web server may be made aware of the limitations or specifications of the requesting device in another way. If it is determined that the requesting device is not a portable communication device or other device having a limited display size, the web server may transmit the web data with the original hyperlinks, that is, the webpage data with the hyperlinks having the original (typically larger) target size and display format (functional block 165).

If it is determined that the device requesting the web data is a portable communication device, at functional block 170, the web server may modify the hyperlink target size, position and/or display format before, at functional block 175, transmitting the web data with the modified hyperlink. It will be appreciated that the modification of the target size, position and/or format of the hyperlink may be performed on the fly or simply by accessing separate HTML data representative of a web page having smaller hyperlink targets more suitable for use in connection with a portable communication device. Also, other web server operation may be used to provide hyperlinks having a target size, position and/or display format suitable for display on a portable communication device without departing from the scope of the present invention.

The use of modified hyperlink targets provides improved performance when a mobile phone having a touch screen user interface is used for mobile web browsing. As is discussed above, the provision of modified hyperlinks may enhance a user's web browsing experience by reducing inadvertent or incidental activation of hyperlinks. Also, the provision of selective disablement of hyperlinks during mobile web browsing may reduce inadvertent launching of hyperlinked web pages, thereby enhancing a user's mobile web browsing experience.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable communication device comprising:
a housing;
a touch input display disposed within the housing; and
a web access interface stored in a memory on the portable communication device, wherein when the web access interface is executed, the web access interface causes the portable communication device to:
receive web data representative of a web page for display on the portable communication device, wherein the web page includes at least one hyperlink having a target size and a display format relative to the web page;
modify the target size and/or display characteristic of the at least one hyperlink relative to the web page; and
display the web page with the modified hyperlink on the touch input display.

2. The portable communication device according to claim 1, wherein the web access interface causes the portable communication device to reduce the target size of at least one hyperlink relative to the web page.

3. The portable communication device according to claim 1, wherein the web access interface causes the portable communication device to adjust a position of the at least one hyperlink target relative to the web page.

4. The portable communication device according to claim 1, wherein the web access interface causes the portable communication device to display the at least one hyperlink target adjacent to a border of a viewing window on the touch input display.

5. The portable communication device according to claim 4, wherein the hyperlink target is displayed with a visual indicator connecting the modified hyperlink target with associated hyperlink text or image.

6. The portable communication device according to claim 1, wherein modifying the display format of the at least one hyperlink includes displaying a pop up confirmation prompt in association with a hyperlink, wherein the pop up confirmation prompt is presented in response to detection of activation of a hyperlink on the web page.

7. A method of displaying a web page having hyperlinks on a portable communication device, the method comprising:
receiving web data representative of a web page for display on the portable communication device, wherein the web page includes at least one hyperlink having a target size and a display format relative to the web page;
modifying the target size and/or display format of the at least one hyperlink relative to the web page; and
displaying the web page with the modified hyperlink on a display of the portable communication device.

8. The method according to claim 7, wherein modifying includes reducing the target size of the at least one hyperlink.

9. The method according to claim 8, wherein modifying the display format of the at least one hyperlink includes reformatting the hyperlink such that only a portion of the original hyperlink target is active in the modified hyperlink.

10. The method according to claim 9, wherein the original hyperlink includes a word or phrase, and only the first letter of the word or phrase of the original hyperlink is active in the modified hyperlink.

11. The method according to claim 9, wherein the original hyperlink includes an image or an icon, and only a portion of the image or icon is active in the modified hyperlink.

12. The method according to claim 7, wherein modifying includes adjusting a position of the at least one hyperlink target relative to the web page.

13. The method according to claim 7, wherein modifying includes moving the at least one hyperlink target adjacent to a border of a viewing window on the display.

14. The method according to claim 13, wherein the modified hyperlink target includes a visual indicator connecting the modified hyperlink target with an associated hyperlink text or image.

15. The method according to claim 7, wherein modifying includes displaying a pop up confirmation prompt in association with a hyperlink, wherein the pop up confirmation prompt is presented in response to detection of activation of a hyperlink on the web page.

16. A method of displaying a web page having hyperlinks on a portable communication device, the method comprising:
receiving web data representative of a web page for display on the portable communication device, wherein the web page includes at least one hyperlink of a first target size and a display characteristic relative to the web page;
providing a user of the portable communication device with a prompt to temporarily disable hyperlinks in the web page for display;
disabling hyperlinks in response to a user command to temporarily disable hyperlinks on the web page; and
displaying the web page with the at least one hyperlink disabled.

17. The method according to claim 16, wherein providing a user of the portable communication device with a prompt includes displaying a soft key that is activatable to disable hyperlinks in the web page for display.

18. The method according to claim 16, further comprising:
providing the user with a control operative to disable hyperlinks on the web page when the control is engaged by the user of the portable communication device.

19. A method of providing web data for display on a portable communication device, the method comprising:
storing web data representative of a web page, the web page including at least one hyperlink having a target size and a display format;
determining whether a requesting device is a portable communication device; and
if the requesting device is a portable communication, changing the target size and/or display format of the at least one hyperlink for display on the portable communication device.

20. A method of web browsing on a portable communication device, the method comprising:
for web data representative of a web page, where the web page includes at least one hyperlink having a target size and a display format relative to the web page, changing a target size, display position and/or display format of the at least one hyperlink relative to the web page for display on the portable communication device.

21. The method according to claim 20, wherein the changing is performed by a web browser stored in a memory of the portable communication device.

22. The method according to claim 20, wherein the changing is performed by a web server in data communications with the portable communication device.

23. A portable communication device comprising:
a housing;
a touch input display disposed within the housing; and
a web access interface stored in a memory on the portable communication device, wherein the web access interface provides a web access user interface in which hyperlink targets within web pages are displayed with reduced target size, modified target position and/or modified display format to reduce incidental activation of hyperlinks during web page navigation.
